(19) United States
(12) Patent Application Publication
(10) Pub. No.: US 2017/0131509 A1
(43) Pub. Date: May 11, 2017

(54) TOWING ASSEMBLY, FIBER OPTIC CONNECTOR AND METHODS OF PRODUCING AND ASSEMBLING THE SAME

(71) Applicant: TYCO ELECTRONICS (SHANGHAI) CO. LTD., Shanghai (CN)

(72) Inventors: Taiyan XIAO, Shanghai (CN); Yanhong YANG, Shanghai (CN); Yang YI, Shanghai (CN); Xin TIAN, Shanghai (CN)

(21) Appl. No.: 15/322,023

(22) PCT Filed: Jun. 18, 2015
(86) PCT No.: PCT/IB2015/054593

§ 371 Date: Dec. 23, 2016

(30) Foreign Application Priority Data
Jun. 24, 2014 (CN) 201410287048.5

(51) Int. Cl. G02B 6/44; G02B 6/38

(52) U.S. Cl. CPC G02B 6/4465; G02B 6/3849; G02B 6/3851; G02B 6/3861; G02B 6/3887; G02B 6/3894

(57) ABSTRACT

A fiber optic connector includes: a housing and an integrated ferrule assembly. N positioning keys are formed on an outer periphery of a ferrule tail seat of the ferrule, wherein N is an integer equal to or greater than two, the N positioning keys are spaced at an equal angle around the outer periphery of the ferrule tail seat, and one of the N positioning keys corresponding to an eccentric orientation of an optical fiber secured in the ferrule is cut out to form a cutting portion; (N−1) positioning slots, which correspond to (N−1) positioning keys on the ferrule tail seat, respectively, are formed in the housing, and there is no positioning slot formed in a part of the housing corresponding to the cutting portion, such that the integrated ferrule assembly may be inserted into the housing only when the N−1 positioning keys are aligned with the (N−1) positioning slots respectively. Thus, the fiber optic connector is adapted to be assembled and detached in the field, preventing effectively the ferrule assembly of the fiber optic connector from being inserting into the housing thereof in an incorrect orientation angle.

### CROSS-REFERENCE TO RELATED APPLICATION

This application claims the benefit of Chinese Patent Application No. 201410287048.5 filed on Jun. 24, 2014 in the State Intellectual Property Office of China, the whole disclosure of which is incorporated herein by reference.

### BACKGROUND OF THE INVENTION

Field of the Invention

The present invention relates to a fiber optic connector, a towing assembly, a method for producing a fiber optic connector and a field assembling method of a fiber optic connector.

Description of the Related Art

In the prior art, when a fiber optic connector is required to pass through an elongated pipe, two methods are usually employed, a first method is to sleeve a towing member on a housing of the fiber optic connector and a towing rope is connected to the towing member so as to tow the fiber optic connector through the elongated pipe; a second method is to fasten the towing rope onto the fiber optic connector directly so as to tow the fiber optic connector through the elongated pipe.

With regard to the first method, it is necessary to use a dedicated tool to assemble the towing member onto the fiber optic connector, thus, generally, the towing member is directly assembled onto the fiber optic connector in factory and is sold with the fiber optic connector. Also it is necessary to use a dedicated tool to remove the towing member from the fiber optic connector after the fiber optic connector passes through the elongated pipe, thus, it is not convenient to perform such towing operation and the cost is high.

With regard to the second method, it is simple, but the ferrule assembly of the fiber optic connector is exposed directly in the pipe and is easy to be damaged by contaminants in the pipe and thus a quality of the fiber optic connector is affected.

There is also a common issue both in the above methods, that is, the fiber optic connector cannot pass through a narrow elongated pipe when the housing of the fiber optic connector has a large size. In order to solve this issue, the inventor has proposed a new technical solution, in which the housing of the fiber optic connector is removed before passing through the elongated pipe, and a ferrule assembly is towed through the pipe, then the ferrule assembly is mounted into the housing.

However, in the prior art, all of a plurality of positioning keys on the ferrule assembly and a plurality of corresponding positioning slots in the housing are spaced at an equal angle, so that the ferrule assembly may be inserted into the housing in multiple different manners. In order to ensure the ferrule assembly is inserted into the housing in a correct orientation (an eccentric orientation of an optical fiber in the ferrule assembly points toward an upper portion of the housing in a vertical direction when the ferrule assembly is inserted into the housing in a correct orientation), it is required to identify an eccentric orientation label on the ferrule assembly and to locate it at a vertically upward orientation. However, in the field environment, a field operator is apt to neglect this issue and insert the ferrule assembly into the housing in an incorrect orientation, which causes the eccentric orientation of an optical fiber in the ferrule assembly is not located in a predetermined orientation of the housing, increasing an insertion loss when two fiber optic connectors are mated.

### SUMMARY OF THE INVENTION

An objective of the present invention aims to solve at least one aspect of the above issues and disadvantages in the prior art.

According to embodiments of the present invention, there is to provide a fiber optic connector, which is adapted to be assembled and detached in the field and prevents effectively the ferrule assembly of the fiber optic connector from being inserting into the housing thereof in an incorrect orientation angle.

According to an aspect of the present invention, provided is a fiber optic connector comprising: a housing; a housing; and an integrated ferrule assembly adapted to be inserted into or pulled out of the housing in a manner of a single piece. N positioning keys are formed on an outer periphery of a ferrule tail seat of the ferrule assembly, wherein N is an integer equal to or greater than two, the N positioning keys are spaced each other at an equal angle around the outer periphery of the ferrule tail seat, and one of the N positioning keys corresponding to an eccentric orientation of an optical fiber fixed in the ferrule assembly is cut off to form a cutting portion; (N−1) positioning slots, which correspond to (N−1) positioning keys on the ferrule tail seat respectively, are formed in the housing, and there is no positioning slots formed in a part of the housing corresponding to the cutting portion, such that the integrated ferrule assembly is allowed to be inserted into the housing only when the (N−1) positioning keys are aligned with the (N−1) positioning slots, respectively.

According to an exemplary embodiment of the present invention, the integrated ferrule assembly comprises a ferrule body, a ferrule tail seat, a spring, a spring seat, a crimp ring, a shrinkable tube, a boot, an optical cable and a dust cap which are assembled into a single piece.

According to another exemplary embodiment of the present invention, the ferrule tail seat is connected to a rear end of the ferrule body; the spring is held in a receiving chamber at a front end of the spring seat, and a rear end of the ferrule tail seat is inserted into the receiving chamber and presses against the spring; a reinforcing element of the optical cable is pressed against a rear end of the spring seat by the crimp ring, and the optic fiber of the optic cable passes through an inner hole of the ferrule and is secured in the inner hole of the ferrule by glue; one end of the shrinkable tube is thermally shrunk on the crimp ring and the other end thereof is thermally shrunk on the optical cable; the boot is sleeved on the shrinkable tube and is connected to the spring seat; and the dust cap is sleeved on a front end of ferrule body.

According to another exemplary embodiment of the present invention, the part of the housing corresponding to the cutting portion is located at an upper portion of the housing in a vertical direction.

According to another exemplary embodiment of the present invention, the housing comprises an outer housing and an inner housing mounted in the outer housing; the positioning slots are formed in the inner housing, and the integrated ferrule assembly is inserted into the inner housing.

According to another exemplary embodiment of the present invention, an outer surface at the rear end of the spring seat is formed as a coarse surface.

According to another exemplary embodiment of the present invention, a protrusion is formed on the rear end of the ferrule tail seat and an opening is formed in a wall of the receiving chamber of the spring seat, and the protrusion of the ferrule tail seat is engaged into the opening of the spring seat.

According to another exemplary embodiment of the present invention, an elongated slot is also formed in the wall of the receiving chamber of the spring seat in order to separate the wall of the receiving chamber in its circumferential direction.

According to another aspect of the present invention, provided is a towing assembly comprising: an integrated ferrule assembly comprising a ferrule body, a ferrule tail seat, a spring, a spring seat, a crimp ring, a shrinkable tube, a boot, an optical cable and a dust cap which are assembled into one part with each other; and a towing portion sleeved hermetically on the spring seat of the integrated ferrule assembly. Internal threads are formed on an inner wall of the towing portion and external threads are formed on an outer wall of the spring seat, and the towing portion is threaded to the spring seat. A groove is formed on the outer wall of the spring seat and an elastic seal ring is disposed in the groove, the inner wall of the towing portion presses against the elastic seal ring when the towing portion is sleeved on the spring seat, so that a fitting interface between the towing portion and the integrated ferrule assembly is sealed; and N positioning keys are formed on an outer periphery of the ferrule tail seat, wherein N is an integer equal to or greater than two, the N positioning keys are spaced at an equal angle around the outer periphery of the ferrule tail seat, and one of the N positioning keys corresponding to an eccentric orientation of an optical fiber secured in the ferrule is cut off to form a cutting portion.

According to an embodiment of the present invention, one end of the towing portion is provided with a connecting lug for connecting a towing cable.

According to another exemplary embodiment of the present invention, the ferrule tail seat is connected to a rear end of the ferrule body; the spring is held in a receiving chamber at a front end of the spring seat, and a rear end of the ferrule tail seat is inserted into the receiving chamber and presses against the spring; a reinforcing element of the optical cable is pressed against a rear end of the spring seat by the crimp ring, and the optic fiber of the optic cable passes through an inner hole of the ferrule and is secured in the inner hole of the ferrule by glue; one end of the shrinkable tube is thermally shrunk on the crimp ring and the other end thereof is thermally shrunk on the optical cable; the boot is sleeved on the shrinkable tube and is connected to the spring seat; and the dust cap is sleeved on a front end of ferrule body.

According to another exemplary embodiment of the present invention, an outer surface at the rear end of the spring seat is formed as a coarse surface.

According to another exemplary embodiment of the present invention, a protrusion is formed on the rear end of the ferrule tail seat, an opening is formed in a wall of the receiving chamber of the spring seat, and the protrusion of the ferrule tail seat is assembled into the opening of the spring seat.

According to another exemplary embodiment of the present invention, an elongated slot is also formed in the wall of the receiving chamber of the spring seat in order to separate the wall of the receiving chamber in its circumferential direction.

According to another aspect of the present invention, provided is a method for producing the fiber optic connector of any one of above embodiments, comprising steps of:
assembling a ferrule body, a ferrule tail seat, a spring, a spring seat, a optical cable, a crimp ring, a shrinkable tube, a boot and a dust cap;
curing glue in the ferrule to fix an optical fiber of the optical cable in an inner hole of the ferrule so as to form an integrated ferrule assembly;
determining an eccentric orientation of the optical fiber in the integrated ferrule assembly, and cutting off one of the N positioning keys corresponding to the eccentric orientation of the optical fiber to form a cutting portion; and
inserting the integrated ferrule assembly with the cut-off positioning key into the housing, wherein (N−1) positioning slots, which correspond to (N−1) positioning keys on the ferrule tail seat, respectively, are formed in the housing, and there is no positioning slot formed in a part of the housing corresponding to the cutting portion.

According to another aspect of the present invention, provided is a field assembling method of a fiber optic connector comprising steps of:
providing an integrated ferrule assembly;
sleeving hermetically a towing portion on the integrated ferrule assembly;
towing the towing portion to pass the integrated ferrule assembly through an elongated pipe;
removing the towing portion from the integrated ferrule assembly; and
inserting the integrated ferrule assembly into a housing of the connector.

According to an exemplary embodiment of the present invention, internal threads are formed on an inner wall of the towing portion and external threads are formed on an outer wall of the spring seat of the integrated ferrule assembly, and the towing portion is threaded to the spring seat; a groove is formed on the outer wall of the spring seat and an elastic seal ring is disposed in the groove, the inner wall of the towing portion presses against the elastic seal ring when the towing portion is sleeved on the spring seat, so that a fitting interface between the towing portion and the integrated ferrule assembly is sealed.

The fiber optic connector of the present invention is adapted to be assembled and detached in the field, preventing effectively the ferrule assembly of the fiber optic connector from being inserting into the housing thereof in a wrong orientation angle.

Other objectives and advantages of the present invention will become more apparent by describing the present invention with reference to the accompanying drawings in the following, it may also aid to give a complete comprehension of the present invention.

### BRIEF DESCRIPTION OF THE DRAWINGS

FIG. 1 shows a perspective schematic view of a ferrule assembly of a fiber optic connector according to an embodiment of the present invention;

FIG. 2a shows a perspective schematic view of an entire fiber optic connector formed by inserting the ferrule assembly of FIG. 1 into a housing of the fiber optic connector;

FIG. 2b shows an exploded schematic view of the fiber optic connector of FIG. 2a, in which an elastic seal ring, a crimp ring, a shrinkable tube and a boot on the ferrule assembly are not shown;

FIG. 3a shows a perspective schematic view of a towing assembly after a towing member is assembled onto the ferrule assembly of FIG. 1;

FIG. 3b shows an exploded schematic view of the towing assembly of FIG. 3a, in which the elastic seal ring, the crimp ring, the shrinkable tube and the boot on the ferrule assembly are not shown;

FIG. 4 shows a section view of the ferrule assembly of FIG. 1, in which the crimp ring, the shrinkable tube and the boot on the ferrule assembly are not shown;

FIG. 5 shows an enlarged schematic view of the ferrule of the ferrule assembly of FIG. 1;

FIG. 6 shows an enlarged schematic view of the spring seat of the ferrule assembly of FIG. 1;

FIG. 7 shows an enlarged schematic view of the ferrule assembly of FIG. 1, in which the elastic seal ring and the boot are not shown;

FIG. 8 shows a schematic view of the ferrule assembly of FIG. 7, in which one positioning key of the spring seat corresponding to the eccentric orientation of the optical fiber is cut out;

FIG. 9 shows a perspective schematic view of an inner housing of a fiber optic connector according to an embodiment of the present invention, in which a part of the inner housing has been cut out to show each positioning slot formed in the inner housing; and

FIG. 10 shows an end view of the inner housing of FIG. 9.

### DETAILED DESCRIPTION OF PREFERRED EMBODIMENTS OF THE INVENTION

The technical solutions of the present invention are further explained specifically in the following by embodiments and in combination with accompanying drawings. The same or similar reference numbers indicate the same or similar parts in the description. The following explanation of the embodiments of the present invention with reference to the drawings intends to explain the general inventive concept of the present invention, but cannot be interpreted as a limitation to the present invention.

Moreover, in the following detailed description, for the purpose of explanation, a number of specific details are explained in order to provide a complete comprehension to the disclosed embodiments. However, it is obvious that one or more embodiments may be implemented without these specific details. In other cases, well known structures and devices are embodied in a form of illustration to simplify the drawings.

According to a general technical concept of the present invention, provided is a fiber optic connector comprising: a housing; and an integrated ferrule assembly adapted to be inserted into or pulled out of the housing in a manner of a single piece. N positioning keys are formed on an outer periphery of a ferrule tail seat of the ferrule assembly, wherein N is an integer equal to or greater than two, the N positioning keys are spaced each other at an equal angle around the outer periphery of the ferrule tail seat, and one of the N positioning keys corresponding to an eccentric orientation of an optical fiber fixed in the ferrule assembly is cut off to form a cutting portion. (N−1) positioning slots, which correspond to (N−1) positioning keys on the ferrule tail seat respectively, are formed in the housing, and there is no positioning slots formed in a part of the housing corresponding to the cutting portion, such that the integrated ferrule assembly is allowed to be inserted into the housing only when the (N−1) positioning keys are aligned with the (N−1) positioning slots, respectively.

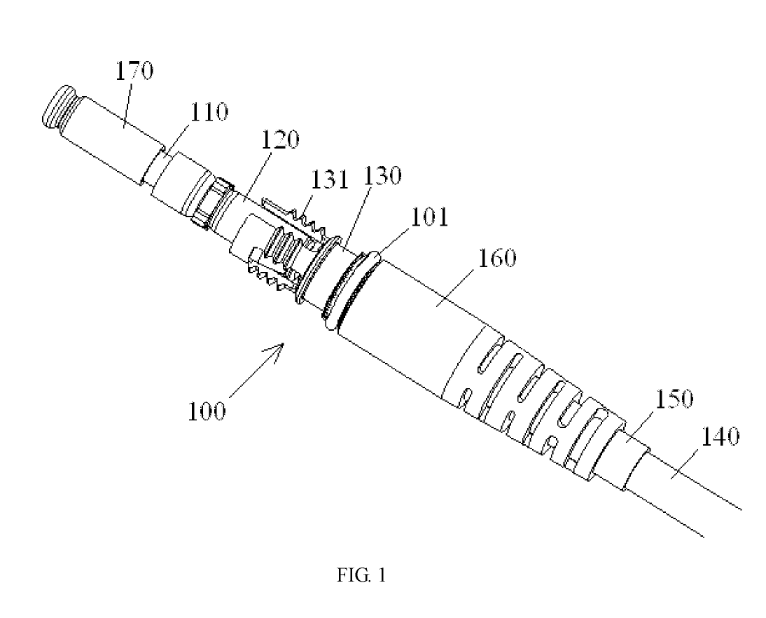

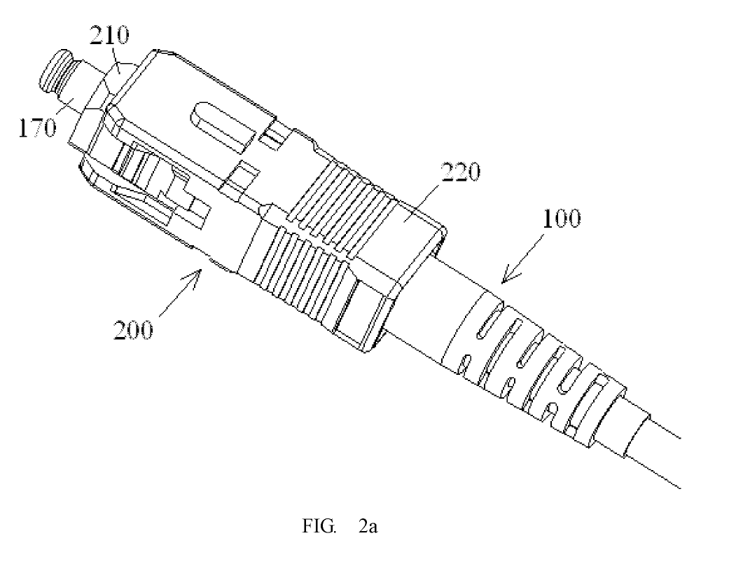

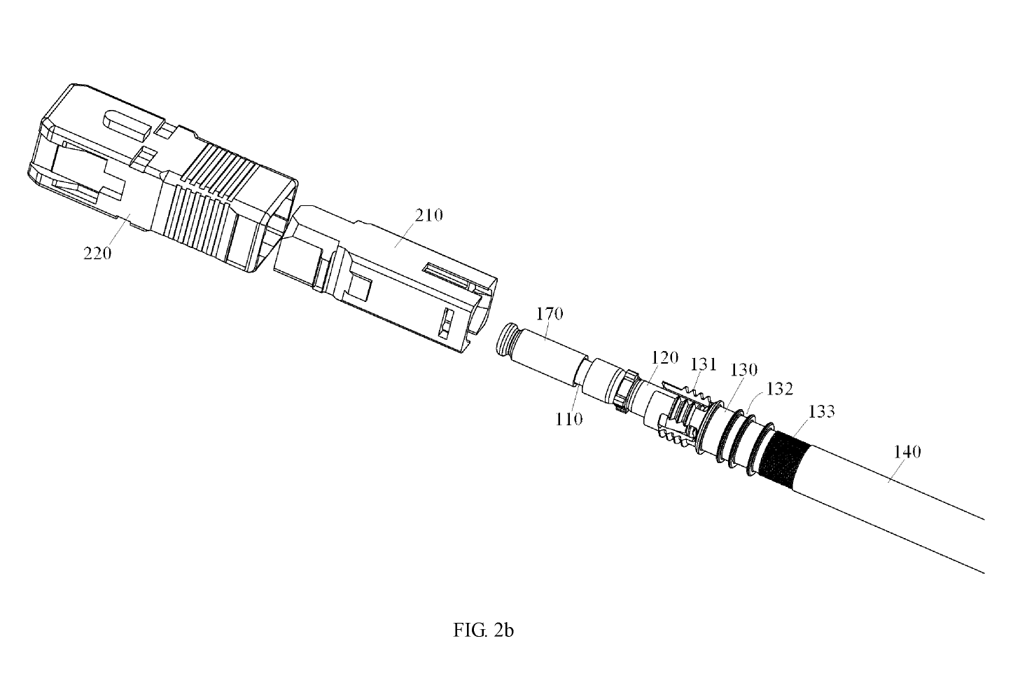

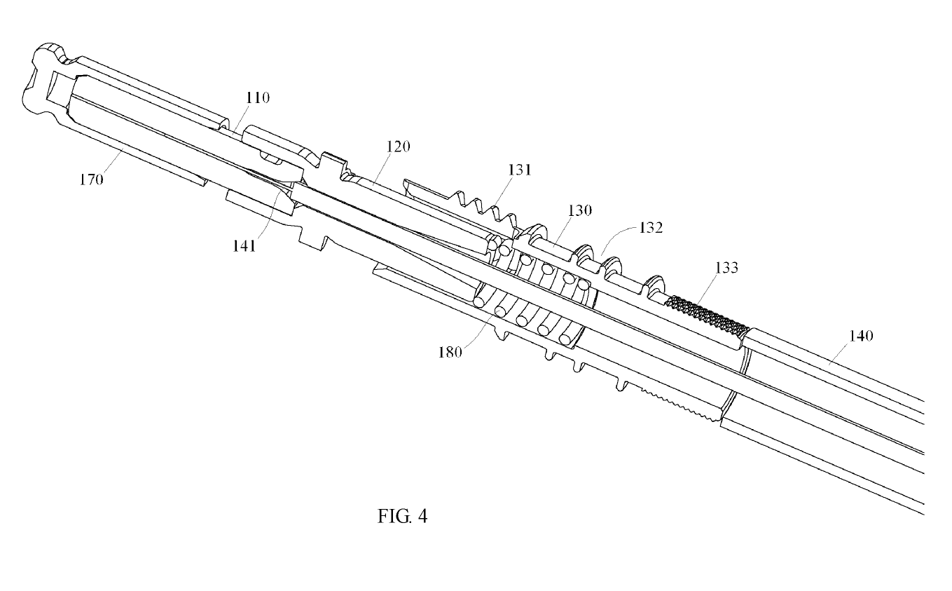

FIG. 1 shows a perspective schematic view of a ferrule assembly 100 of a fiber optic connector according to an embodiment of the present invention. FIG. 2a shows a perspective schematic view of an entire fiber optic connector formed by inserting the ferrule assembly 100 of FIG. 1 into a housing 200 of the fiber optic connector; FIG. 2b shows an exploded schematic view of the fiber optic connector of FIG. 2a, in which an elastic seal ring 101, a crimp ring (not shown), a shrinkable tube 150 and a boot 160 on the ferrule assembly 100 are not shown. FIG. 4 shows a section view of the ferrule assembly 100 of FIG. 1, in which the crimp ring, the shrinkable tube 150 and the boot 160 on the ferrule assembly are not shown.

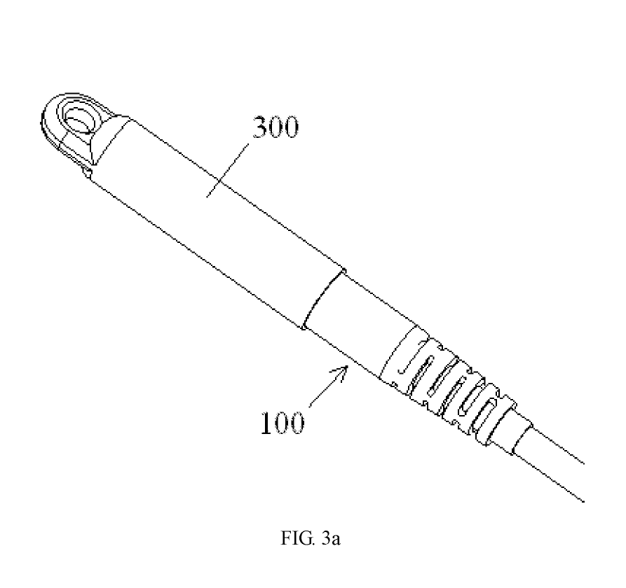

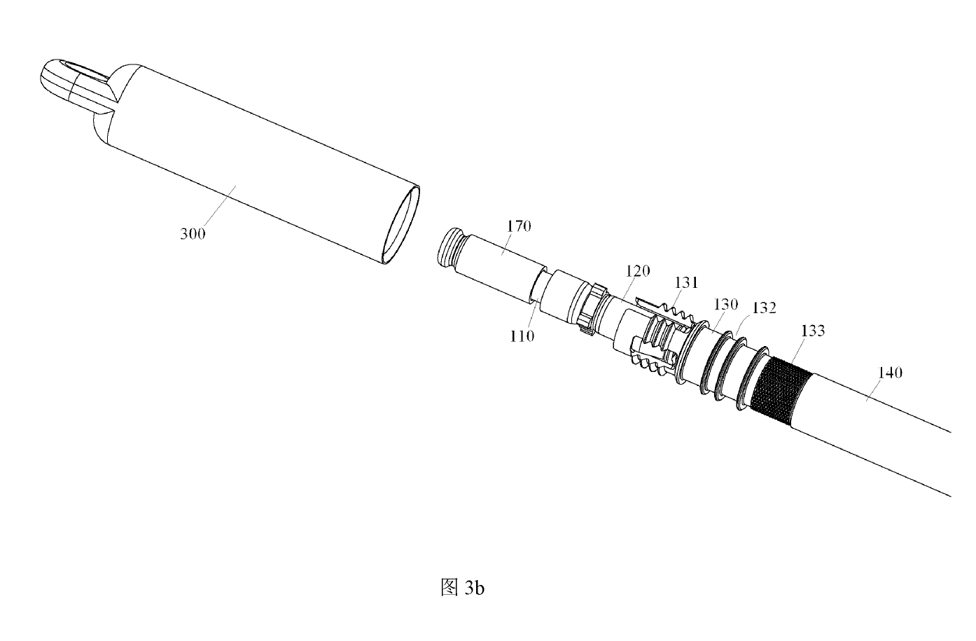

As shown in FIGS. 1, 2a, 2b and 4, in the illustrated embodiment, the entire fiber optic connector mainly comprises a housing 200 and an integrated ferrule assembly 100. As shown in FIG. 1 clearly, the integrated ferrule assembly 100 is adapted to be inserted into or pulled out of the housing 200 in a manner of a single piece. Thus, the ferrule assembly 100 may conveniently be removed from the housing 200 and assembled with a towing portion 300 (refer to FIG. 3 as explained in detail hereafter), it is convenient to pass the ferrule assembly 100 through an elongated pipe by using the towing portion 300. Thereafter, an operator may assemble conveniently the ferrule assembly 100 into the housing 200 again in the field to form the entire fiber optic connector.

Continued to see FIGS. 1, 2a, 2b and 4, in the illustrated embodiment, the integrated ferrule assembly 100 mainly comprises a ferrule body 110, a ferrule tail seat 120, a spring 180, a spring seat 130, a crimp ring (not shown, used to press a reinforcing element of an optical fiber 140, such as Kevlar fiber, against a rear end 133 of the spring seat 130), a shrinkable tube 150, a boot 160 for strain relief, an optical cable 140 and a dust cap 170. As shown in FIG. 1 clearly, the ferrule body 110, the ferrule tail seat 120, the spring 180, the spring seat 130, the crimp ring, the shrinkable tube 150, the boot 160, the optical cable 140 and the dust cap 170 are assembled together to form the integrated ferrule assembly 100 as shown in FIG. 1.

As shown in FIGS. 1, 2a, 2b and 4, in an embodiment of the present embodiment, the ferrule comprises the ferrule body 110 and the ferrule tail seat 120 connected to a rear end of the ferrule body 110. The spring 180 is received in a receiving chamber formed at a front end of the spring seat 130, and a rear end of the ferrule tail seat 120 is inserted into the receiving chamber and presses against the spring 180. A reinforcing element of the optical cable 140 is pressed against a rear end 133 of the spring seat 130 by the crimp ring. One end of the shrinkable tube 150 is thermally shrunk on the crimp ring and the other end thereof is thermally shrunk on the optical cable 140. The boot 160 is sleeved on the shrinkable tube 150 and is connected to the spring seat 130. The dust cap 170 is sleeved on a front end of ferrule body 110. Thereby, the ferrule body 110, the ferrule tail seat 120, the spring 180, the spring seat 130, the crimp ring, the shrinkable tube 150, the boot 160, the optical cable 140 and the dust cap 170 are assembled together to form the integrated ferrule assembly 100 as shown in FIG. 1.

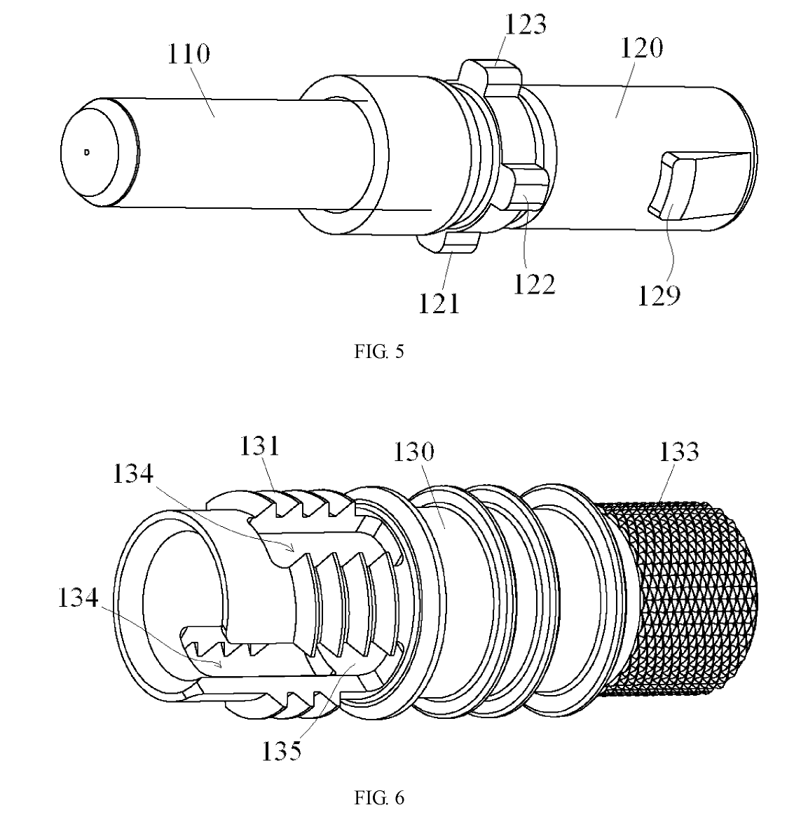

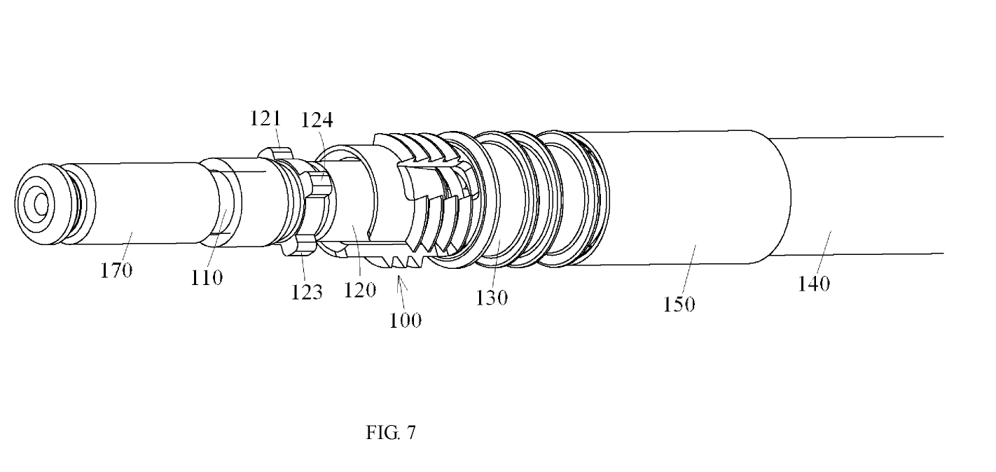

FIG. 5 shows an enlarged schematic view of the ferrule of the ferrule assembly 100 of FIG. 1; FIG. 6 shows an enlarged schematic view of the spring seat 130 of the ferrule assembly 100 of FIG. 1.

As shown in FIG. 5 and FIG. 6, in the illustrated embodiment, a pair of protrusions 129 are formed on the rear end of the ferrule tail seat 120 and a pair of openings 134 are formed in a wall of the receiving chamber of the spring seat 130. The protrusions 129 of the ferrule tail seat 120 are engaged into the openings 134 of the spring seat 130, so that the ferrule tail seat 120 and the spring seat 130 are engaged together with each other.

As shown in FIG. 6, in an embodiment of the present invention, an outer surface at the rear end 133 of the spring seat 130 is formed as a coarse surface.

In an embodiment of the present invention, as shown in FIG. 6, an elongated slot 135 is formed in the wall of the receiving chamber of the spring seat 130 in order to separate the wall of the receiving chamber in its circumferential direction. Thereby, a stiffness of the wall of the receiving chamber is reduced, facilitating to insert the ferrule tail seat 120 with the protrusions 129 into the receiving chamber of the spring seat 130.

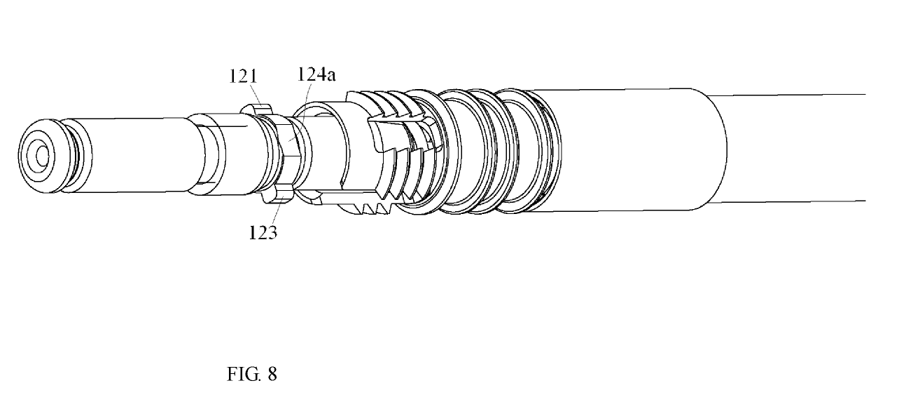

FIG. 7 shows an enlarged schematic view of the ferrule assembly 100 of FIG. 1, in which the elastic seal ring 101 and the boot 160 are not shown.

As shown in FIG. 5 and FIG. 7, in the illustrated embodiment, four positioning keys 121, 122, 123, 124 are formed on an outer periphery of the ferrule tail seat 120 of the ferrule, and the four positioning keys 121, 122, 123, 124 are arranged to be spaced at an equal angle (for example, 90 degrees) around the outer periphery of the ferrule tail seat 120.

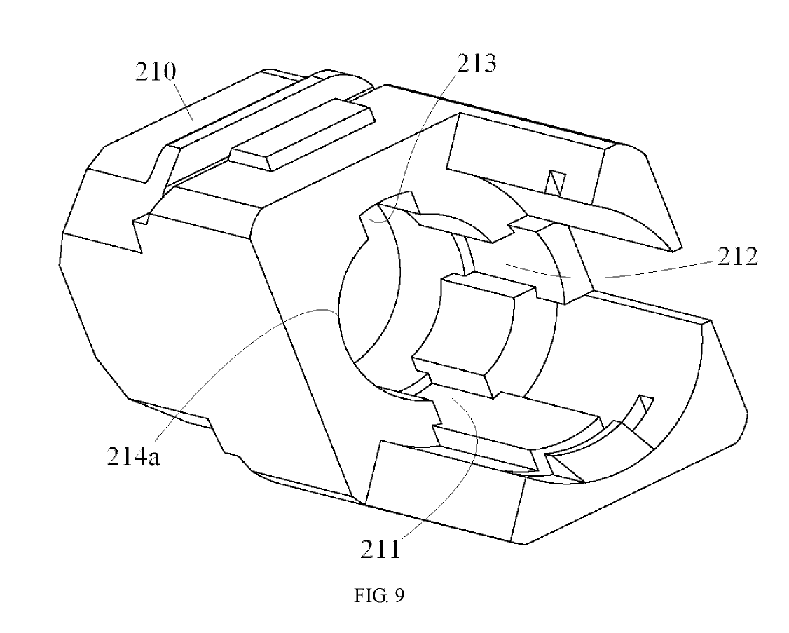

FIG. 8 shows a schematic view of the ferrule assembly 100 of FIG. 7, in which one positioning key 124 on the spring seat 130 corresponding to the eccentric orientation of the optical fiber 140 is cut off.

As shown in FIG. 8, in an embodiment of the present invention, in factory, after forming the integrated ferrule assembly 100 as shown in FIG. 1, an aligning operation of the ferrule assembly 100 is performed to determine the eccentric orientation of the optical fiber 141 in the integrated ferrule assembly 100. For example, in the illustrated embodiment, the positioning key 124 on the spring seat 130 is arranged to correspond to the eccentric orientation of the optical fiber 141, and the positioning key 124 is completely cut off from its root, a cutting portion 124a is thus formed on the spring seat 130.

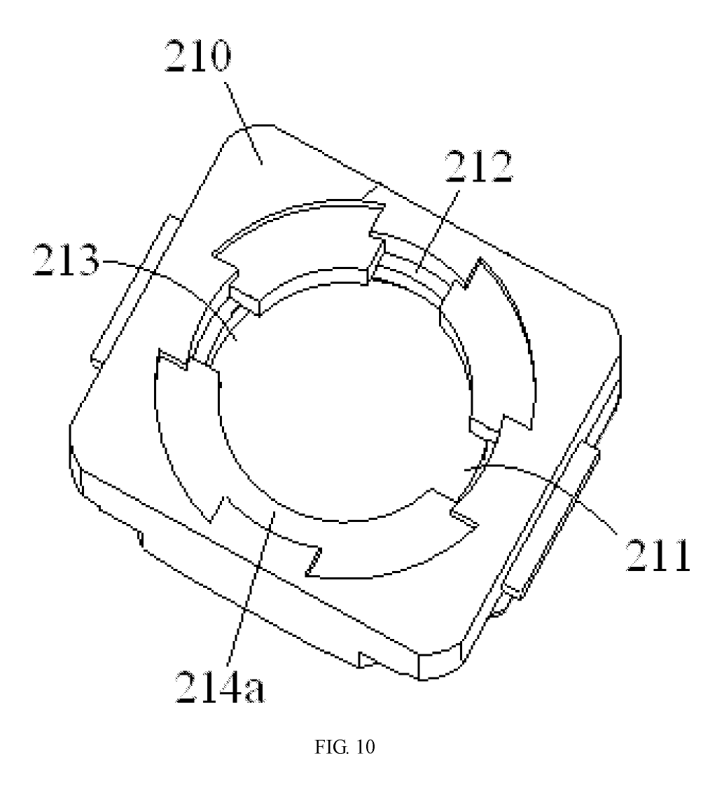

FIG. 9 shows a perspective schematic view of the inner housing 210 of the fiber optic connector according to an embodiment of the present invention, in which a part of the inner housing 210 has been cut off to show each positioning slot 211, 212, 213 in the inner housing 210; and FIG. 10 shows an end view of the inner housing 210 of FIG. 9.

As shown in FIGS. 2a, 2b, 9 and 10, in the illustrated embodiment, the housing 200 comprises an outer housing 220 and an inner housing 210 formed in the outer housing 220. The integrated ferrule assembly 100 is adapted to be inserted into the inner housing 210.

As shown in FIGS. 7, 8, 9 and 10, in the illustrated embodiment, three positioning slots 211, 212, 213 are formed in the inner housing 210 and correspond to the three positioning keys 121, 122, 123 on the ferrule tail seat 120 of the ferrule assembly 100 respectively.

As shown in FIGS. 7, 8, 9 and 10, there is no positioning key formed in the part 214a on the inner housing 210 which is in correspondence to the cutting portion 124a. Thereby, the ferrule assembly 100 may be inserted into the inner housing 210 only in unique orientation angle relative to the inner housing 210 when the ferrule assembly 100 is assembled into the housing 210 in the field. That is, the integrated ferrule assembly 100 is allowed to be inserted into the housing 200 only when the three positioning keys 121, 122, 123 on the ferrule assembly 100 are aligned and engaged with the three positioning slots 211, 212, 213 in the inner housing 210, respectively. Thus, it is able to ensure that the ferrule assembly 100 is always inserted into the inner housing 210 in a unique correct orientation angle after the aligning operation.

In the illustrated embodiment, four positioning keys 121, 122, 123, 124 are firstly formed on the ferrule tail seat 120, then one positioning key 124 corresponding to the eccentric orientation of the optical fiber 141 is cut off, and only three positioning slots 211, 212, 213, which correspond to the left three positioning keys 121, 122, 123, respectively, are formed in the inner housing 210.

However, the present invention is not limited to the illustrated embodiment. In another exemplary embodiment of the present invention, N positioning keys are formed on an outer periphery of the ferrule tail seat 120 of the ferrule assembly, wherein N is an integer equal to or greater than two, the N positioning keys are arranged to be spaced at an equal angle (360/N degrees) around the outer periphery of the ferrule tail seat 120, and one of the N positioning keys corresponding to the eccentric orientation of the optical fiber 141 fixed in the ferrule is cut off to form the cutting portion. (N−1) positioning slots, which correspond to (N−1) positioning keys formed on the ferrule tail seat 120, respectively, are formed in the housing 200, and there is no positioning slot is not formed in a part of the housing 200 corresponding to the cutting portion, such that the integrated ferrule assembly 100 is allowed to be inserted into the housing 200 only when the (N−1) positioning keys are aligned with the N−1 positioning slots, respectively.

In an exemplary embodiment of the present invention, the part 214a of the housing 200 corresponding to the cutting portion 124a is located at an upper portion of the housing in a vertical direction. Thus, when coupling two fiber optic connectors using an adapter, it is only required to set the eccentric orientations of the two fiber optic connectors to a straight upward orientation so as to reduce an eccentric amount between optical fibers held in the two coupled fiber optic connectors and to reduce an insertion loss when coupling the two fiber optic connectors.

In another embodiment of the present invention, as shown in FIGS. 1-2 and FIGS. 4-10, a method for producing the fiber optic connector as described above is also disclosed, it mainly comprises steps of:
S101. assembling the ferrule body 110, the ferrule tail seat 120, the spring 180, the spring seat 130, the optical cable 140, the crimp ring, the shrinkable tube 150, the boot 160 and the dust cap 170 into a single piece;
S102. curing glue in the ferrule to fix an optical fiber 141 of the optical cable 140 in an inner hole of the ferrule so as to form an integrated ferrule assembly 100;
S103. determining the eccentric orientation of the optical fiber 141 in the integrated ferrule assembly 100, and cutting off one positioning key 124 of the N positioning keys 121, 122, 123, 124 corresponding to the eccentric orientation of the optical fiber 141 to form a cutting portion 124a; and
S104. inserting the integrated ferrule assembly 100 with the cut-off positioning key 124 into the housing 200, wherein (N−1) positioning slots 211, 212, 213, which correspond to (N−1) positioning keys 121, 122, 123 on the ferrule tail seat 120, respectively, are formed in the housing 200, and there is no positioning slot formed in a part 214a of the housing 200 corresponding to the cutting portion 124a.

FIG. 3a shows a perspective schematic view of a towing assembly after a towing portion 300 is assembled onto the ferrule assembly 100 of FIG. 1; FIG. 3b shows an exploded schematic view of the towing assembly of FIG. 3a, in which the elastic seal ring, the crimp ring, the shrinkable tube and the boot on the ferrule assembly are not shown.

As shown in FIG. 3a and FIG. 3b, in an embodiment of the present invention, the towing assembly mainly comprises the integrated ferrule assembly 100 as mentioned above and a towing portion 300.

As described above, referring to FIG. 1 and FIG. 4, the integrated ferrule assembly 100 comprises the ferrule body 110, the ferrule tail seat 120, the spring 180, the spring seat 130, the crimp ring, the shrinkable tube 150, a boot 160, the optical cable 140 and the dust cap 170 which are assembled into a single piece.

As shown in FIG. 3a and FIG. 3b, in the illustrated embodiment, the towing portion 300 is sleeved hermetically on the spring seat 130 of the integrated ferrule assembly 100 from the front end of the ferrule assembly 100.

Continued to refer to FIG. 3a and FIG. 3b, in an embodiment of the present invention, internal threads (not shown) are formed on an inner wall of the towing portion 300 and external threads 131 are formed on an outer wall of the spring seat 130, and the towing portion 300 is threaded to the spring seat 130.

Moreover, as shown in FIGS. 1, 3a and 3b, in the illustrated embodiment, a groove 132 is formed on the outer wall of the spring seat 130 and an elastic seal ring 101 is disposed in the groove 132, the inner wall of the towing portion 300 provided to press against the elastic seal ring 101 when the towing portion 300 is sleeved on the spring seat 130, so that a fitting interface between the towing portion 300 and the integrated ferrule assembly 100 is sealed.

As described above, referring to FIG. 7 and FIG. 8, four positioning keys 121, 122, 123, 124 are formed on an outer periphery of the ferrule tail seat 120 of the ferrule, and the four positioning keys 121, 122, 123, 124 are arranged to be spaced at an equal angle around the outer periphery of the ferrule tail seat 120, and one positioning key 124 of the four positioning keys 121, 122, 123, 124 corresponding to the eccentric orientation of the optical fiber 141 held in the ferrule is cut off to form the cutting portion 124a.

As shown in FIG. 3a and FIG. 3b, in the illustrated embodiment, one end of the towing portion 300 provided with a connecting lug for connecting a towing rope. Thus, the ferrule assembly 100 may pass through the elongated pipe by towing the towing portion 300 connected therewith.

In the following, referring to FIGS. 1 to 10, a field assembling method of a fiber optic connector is explained in detail, the method mainly comprises steps of:
S201. providing an integrated ferrule assembly 100;
S202. sleeving hermetically a towing portion 300 on the integrated ferrule assembly 100;
S203. towing the towing portion 300 to pass the integrated ferrule assembly 100 through an elongated pipe;
S204. removing the towing portion 300 from the integrated ferrule assembly 100; and
S205. inserting the integrated ferrule assembly 100 into the housing 200 of the connector.

Though the present invention is described in combination with the accompanying drawings, the disclosed embodiments with reference to the drawings intend to make an exemplary illustration to the implementations of the present invention, but cannot be interpreted as a limitation to the present invention.

Though some embodiments of the general inventive concept have been shown and explained, it should be understood by those skilled in the art that these embodiments may be modified without departing from the principle and spirit of the general inventive concept, and the scope of the present invention is defined by the claims and equivalents thereof.

It should be noted that, the term “comprising” or “comprise” should be understood as not excluding other elements or steps, the word “a” or “an” should be understood as not excluding plural of said elements or steps. In addition, any reference number in the claims should not be understood as limiting the scope of the present invention.

What is claimed is:

1. A fiber optic connector comprising:
a housing; and
an integrated ferrule assembly adapted to be inserted into or pulled out of the housing in a manner of a single piece;
wherein N positioning keys are formed on an outer periphery of a ferrule tail seat of the ferrule assembly, wherein N is an integer equal to or greater than two, the N positioning keys are spaced each other at an equal angle around the outer periphery of the ferrule tail seat, and one of the N positioning keys corresponding to an eccentric orientation of an optical fiber fixed in the ferrule assembly is cut off to form a cutting portion;
(N−1) positioning slots, which correspond to (N−1) positioning keys on the ferrule tail seat respectively, are formed in the housing, and there is no positioning slots formed in a part of the housing corresponding to the cutting portion, such that the integrated ferrule assembly is allowed to be inserted into the housing only when the (N−1) positioning keys are aligned with the (N−1) positioning slots, respectively.

2. The fiber optic connector of claim 1, wherein the integrated ferrule assembly comprises a ferrule body, a ferrule tail seat, a spring, a spring seat, a crimp ring, a shrinkable tube, a boot, an optical cable and a dust cap which are assembled.

3. The fiber optic connector of claim 2, wherein,
the ferrule tail seat is connected to a rear end of the ferrule body;
the spring is received in a receiving chamber at a front end of the spring seat, and a rear end of the ferrule tail seat is inserted into the receiving chamber and presses against the spring;
a reinforcing element of the optical cable is pressed against a rear end of the spring seat by the crimp ring, and the optic fiber of the optic cable passes through an inner hole of the ferrule and is fixed in the inner hole of the ferrule by glue;
one end of the shrinkable tube is thermally shrunk on the crimp ring and the other end thereof is thermally shrunk on the optical cable;
the boot is sleeved on the shrinkable tube and is connected to the spring seat; and
the dust cap is sleeved on a front end of ferrule body.

4. The fiber optic connector of claim 3, wherein the part of the housing corresponding to the cutting portion is located at an upper portion of the housing in a vertical direction.

5. The fiber optic connector of claim 4, wherein,
the housing comprises an outer housing and an inner housing provided in the outer housing;
the positioning slots are formed in the inner housing, and the integrated ferrule assembly is inserted into the inner housing.

6. The fiber optic connector of claim 5, wherein an outer surface at the rear end of the spring seat is formed as a coarse surface.

7. The fiber optic connector of claim 3, wherein,
a protrusion is formed on the rear end of the ferrule tail seat, an opening is formed in a wall of the receiving chamber of the spring seat, and the protrusion of the ferrule tail seat is engaged into the opening of the spring seat.

8. The fiber optic connector of claim 7, wherein an elongated slot is formed in the wall of the receiving chamber of the spring seat to separate the wall of the receiving chamber in its circumferential direction.

9. A towing assembly comprising:
an integrated ferrule assembly comprising a ferrule body, a ferrule tail seat, a spring, a spring seat, a crimp ring, a shrinkable tube, a boot, an optical cable and a dust cap which are assembled; and
a towing portion sleeved hermetically on the spring seat of the integrated ferrule assembly;
wherein,
internal threads are formed on an inner wall of the towing portion and external threads are formed on an outer wall of the spring seat, and the towing portion is threaded to the spring seat;
a groove is formed on the outer wall of the spring seat and an elastic seal ring is disposed in the groove, the inner wall of the towing portion is provided to press against the elastic seal ring when the towing portion is sleeved on the spring seat, so that a fitting interface between the towing portion and the integrated ferrule assembly is sealed; and
N positioning keys are formed on an outer periphery of the ferrule tail seat, wherein N is an integer equal to or greater than two, the N positioning keys are arranged to be spaced at an equal angle around the outer periphery of the ferrule tail seat, and one of the N positioning keys corresponding to an eccentric orientation of an optical fiber secured in the ferrule is cut off to form a cutting portion.

10. The towing assembly of claim 9, wherein one end of the towing portion is provided with a connecting lug for connecting a towing cable.

11. The towing assembly of claim 9, wherein,
the ferrule tail seat is connected to a rear end of the ferrule body;
the spring is received in a receiving chamber at a front end of the spring seat, and a rear end of the ferrule tail seat is inserted into the receiving chamber and presses against the spring;
a reinforcing element of the optical cable is pressed against a rear end of the spring seat by the crimp ring, and the optic fiber of the optic cable passes through an inner hole of the ferrule and is fixed in the inner hole of the ferrule by glue;
one end of the shrinkable tube is thermally shrunk on the crimp ring and the other end thereof is thermally shrunk on the optical cable;
the boot is sleeved on the shrinkable tube and is connected to the spring seat; and
the dust cap is sleeved on a front end of ferrule body.

12. The towing assembly of claim 11, wherein an outer surface at the rear end of the spring seat is formed as a coarse surface.

13. The towing assembly of claim 12, wherein a protrusion is formed on the rear end of the ferrule tail seat, an opening is formed in a wall of the receiving chamber of the spring seat, and the protrusion of the ferrule tail seat is engaged into the opening of the spring seat.

14. The towing assembly of claim 13, wherein an elongated slot is formed in the wall of the receiving chamber of the spring seat to separate the wall of the receiving chamber in its circumferential direction.

15. A method for producing the fiber optic connector of claim 1, comprising steps of:
assembling a ferrule body, a ferrule tail seat, a spring, a spring seat, a optical cable, a crimp ring, a shrinkable tube, a boot and a dust cap;
curing glue in the ferrule to fix an optical fiber of the optical cable in an inner hole of the ferrule so as to form an integrated ferrule assembly;
determining an eccentric orientation of the optical fiber in the integrated ferrule assembly, and cutting off one of the N positioning keys corresponding to the eccentric orientation of the optical fiber to form a cutting portion; and
inserting the integrated ferrule assembly with the cut-off positioning key into the housing, wherein (N−1) positioning slots, which correspond to (N−1) positioning keys on the ferrule tail seat, respectively, are formed in the housing, and there is no positioning slot formed in a part of the housing corresponding to the cutting portion.

16. A field assembling method of a fiber optic connector comprising steps of:
providing an integrated ferrule assembly;
sleeving hermetically a towing portion on the integrated ferrule assembly;
towing the towing portion to pass the integrated ferrule assembly through an elongated pipe;
removing the towing portion from the integrated ferrule assembly; and
inserting the integrated ferrule assembly into a housing of the connector.

17. The field assembling method of claim 16, wherein,
internal threads are formed on an inner wall of the towing portion and external threads are formed on an outer wall of the spring seat of the integrated ferrule assembly, and the towing portion is threaded to the spring seat;
a groove is formed on the outer wall of the spring seat and an elastic seal ring is disposed in the groove, the inner wall of the towing portion is provided to press against the elastic seal ring when the towing portion is sleeved on the spring seat, so that a fitting interface between the towing portion and the integrated ferrule assembly is sealed.
